(19) United States
(12) Patent Application Publication
(10) Pub. No.: US 2003/0216152 A1
(43) Pub. Date: Nov. 20, 2003

(54) Mobile telephone terminal and manuscript information input method

(75) Inventor: Yoshimi Fukagawa, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/435,372

(22) Filed: May 12, 2003

(30) Foreign Application Priority Data
May 16, 2002 (JP) 2002-141399

(51) Int. Cl. H04M 1/00

(52) U.S. Cl. 455/557; 455/90.2; 455/575.1

(57) ABSTRACT

A mobile telephone terminal wherein even if no displaying circuit corresponding to the file format of manuscript input information is provided, the manuscript input information can be displayed and an image including the manuscript input information can be transmitted to a destination without requiring much processing time is provided. An image input circuit acquires an image photographed by a camera. A displaying circuit displays an image selected by a displayed image selecting circuit on LCD. A transmitting/receiving circuit transmits an image selected by a transmitted image selecting circuit via a radio transmitter-receiver and acquires an image received via the radio transmitter-receiver. A manuscript input circuit acquires manuscript information input from a pointing device. An image/manuscript synthesizing circuit synthesizes an image acquired by the image input circuit and manuscript information acquired by the manuscript input circuit. A storing/reading circuit stores and reads an image in/from a storage.

### BACKGROUND OF THE INVENTION

1. Field of the Invention

The present invention relates to a mobile telephone terminal and a manuscript information input method, particularly relates to a method of adding manuscript information to an image.

2. Description of the Related Art

Recently, a mobile telephone terminal is not limited to the use in a voiced call, and an electronic mail, access to a home page of the Internet, application software such as a game and the downloading of an incoming notifying melody are also enabled.

Some mobile telephone terminals can acquire a digital image by mounting an image sensing device such as a small-sized charge coupled device (CCD) and some terminals transmit an electronic mail with a digital image attached and a digital image itself. In case a digital image is attached to an electronic mail, character information related to the digital image can be also transmitted.

For technique for adding character information to a digital image, there is technique disclosed in Japanese published unexamined patent application No. 2001-21983. According to the technique disclosed in the patent application, information can be written to an image photographed by a camera using a silver salt film and an electronic camera in manuscript. In this case, manuscript information input from a manuscript input circuit is linked to the photographed image, is recorded in a recording circuit and in the case of a silver salt film, the manuscript information is printed in the vicinity of the photographed image.

In the conventional type manuscript information input method described above, as an image and manuscript input information comply with separately defined file formats, there is a problem that in case the other mobile telephone has no displaying circuit corresponding to the file format, the manuscript information cannot be displayed.

Besides, in the conventional type manuscript information input method, as manuscript input information is required to be once stored in a storage when the manuscript input information is synthesized with an image, an image including an image and manuscript input information is required to be once stored in the storage in case the image is transmitted to the other mobile telephone and there is a problem that much processing time is required.

### SUMMARY OF THE INVENTION

The object of the invention is to solve the problems and to provide a mobile telephone terminal and a manuscript information input method wherein even if a displaying circuit corresponding to the file format of manuscript input information is not provided, manuscript input information can be displayed and an image including the manuscript input information can be transmitted without requiring much processing time.

A mobile telephone terminal according to the invention is based upon a mobile telephone terminal to which an image sensing device can be connected and is provided with an image input circuit that acquires an image from the image sensing device, a manuscript input circuit that acquires manuscript input information input from an external device and a synthesizing circuit that synthesizes the image acquired from the image input circuit and the manuscript input information acquired from the manuscript input circuit.

A manuscript information input method according to the invention is based upon a manuscript information input method of a mobile telephone terminal to which an image sensing device can be connected and is provided with a step for determining the acquisition of an image from the image sensing device, a step for determining the acquisition of manuscript input information input from an external device and a step for synthesizing the acquired image and the manuscript input information when the image and the manuscript input information are acquired.

That is, the mobile telephone terminal according to the invention provides the configuration in which a character and a picture respectively input in manuscript (hereinafter called manuscript information) can be written to a photographed image.

To explain more concretely, in the mobile telephone terminal according to the invention, the image input circuit acquires an image from a camera and the displaying circuit displays the acquired image on a liquid crystal display (LCD).

The manuscript input circuit acquires manuscript information input from a pointing device and the synthesizing circuit synthesizes an image acquired by the image input circuit and manuscript information acquired by the manuscript input circuit to be a synthetic image. A transmitting/receiving circuit transmits/receives the synthetic image and a storing/reading circuit stores/reads the synthetic image in/from a storage.

A displayed image selecting circuit selects any of an image acquired by the image input circuit, manuscript information acquired by the manuscript input circuit, a synthetic image synthesized by the synthesizing circuit, an image stored in the storage by the storing/reading circuit and an image received by the transmitting/receiving circuit and the displaying circuit displays it.

A stored image selecting circuit selects any of an image acquired by the image input circuit, manuscript information acquired by the manuscript input circuit, a synthetic image synthesized by the synthesizing circuit and an image received by the transmitting/receiving circuit, sends it to the storing/reading circuit and the storing/reading circuit stores the selected image in the storage.

A transmitted image selecting circuit selects any of an image acquired by the image input circuit, manuscript information acquired by the manuscript input circuit, a synthetic image synthesized by the synthesizing circuit and an image stored in the storage by the storing/reading circuit and the transmitting/receiving circuit transmits it.

As described above, in the mobile telephone terminal according to the invention, as the synthesizing circuit synthesizes an image acquired from the image input circuit and manuscript information acquired from the manuscript input circuit to be a synthetic image, the manuscript information can be easily written to the image, if the image can be displayed even if the displaying circuit corresponding to a file format of the manuscript input information is not provided, the manuscript input information can be also displayed and the image including the manuscript input information can be transmitted without requiring much processing time.

### BRIEF DESCRIPTION OF THE DRAWINGS

The above and other objects, features and advantages of the present invention will become more apparent from the following detailed description when taken in conjunction with the accompanying drawing wherein:

FIG. 1 is a block diagram showing the configuration of a mobile telephone terminal equivalent to one embodiment of the invention;

FIG. 2 is a flowchart showing the operation of the mobile telephone terminal equivalent to one embodiment of the invention; and

FIG. 3 is a flowchart showing the operation of a mobile telephone terminal equivalent to another embodiment of the invention.

### DETAILED DESCRIPTION OF THE PREFERRED EMBODIMENTS

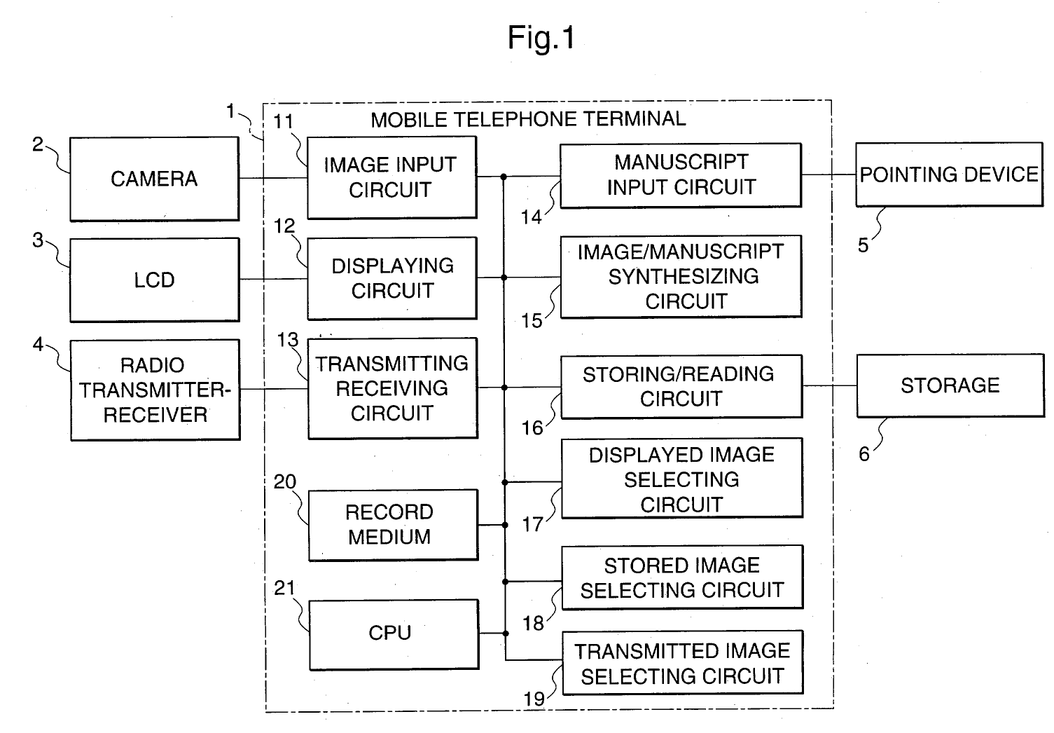

Next, referring to the drawings, embodiments of the invention will be described. FIG. 1 is a block diagram showing the configuration of a mobile telephone terminal equivalent to one embodiment of the invention. As shown in FIG. 1, the mobile telephone terminal 1 is composed of an image input circuit 11, a displaying circuit 12, a transmitting/receiving circuit 13, a manuscript input circuit 14, an image/manuscript synthesizing circuit 15, a storing/reading circuit 16, a displayed image selecting circuit 17, a stored image selecting circuit 18, a transmitted image selecting circuit 19, a record medium 20 and a central processing unit (CPU) 21. Each circuit is controlled when CPU 21 executes a program on the record medium 20.

The image input circuit 11 is connected to a camera 2 and acquires an image photographed by the camera 2. The displaying circuit 12 is connected to LCD 3 and displays an image selected by the displayed image selecting circuit 17 on LCD 3.

The transmitting/receiving circuit 13 is connected to a radio transmitter-receiver 4, the radio transmitter-receiver 4 transmits an image selected by the transmitted image selecting circuit 19 and the transmitting/receiving circuit acquires an image received via the radio transmitter-receiver 4.

The manuscript input circuit 14 is connected to a pointing device 5 and acquires manuscript information input from the pointing device 5. The manuscript input circuit 14 can also enlarge or reduce input manuscript information in response to an instruction from an external device. Besides, the manuscript input circuit 14 can write input manuscript information not only to a fixed position but to an arbitrary position on an image by adding the position to be written on the image directed from an external device to input manuscript information.

Further, the manuscript input circuit 14 can also acquire an arbitrary drawing as manuscript information by providing the pointing device 5 with an auxiliary function for drawing a picture. In this case, for the auxiliary function for drawing a picture, functions for drawing a circle, a straight line and a square are conceivable.

The image/manuscript synthesizing circuit 15 synthesizes an image acquired by the image input circuit 11 and manuscript information acquired by the manuscript input circuit 14 to be a synthetic image. In this case, the image/manuscript synthesizing circuit 15 can easily write the manuscript information acquired by the manuscript input circuit 14 on the image acquired by the image input circuit 11 by tuning the format of the manuscript information acquired by the manuscript input circuit 14 with the format of the image acquired by the image input circuit 11.

For a method of tuning the format of the manuscript information acquired by the manuscript input circuit 14 with the format of the image acquired by the image input circuit 11, a method of outputting input coordinate information as one image from the pointing device 5 and a method of providing an image memory not shown to the manuscript input circuit 14, writing the coordinate information from the pointing device 5 to the image memory and outputting it as an image when it is output from the image memory to the image/manuscript synthesizing circuit 15 are conceivable.

Besides, a method of converting the format of manuscript information acquired by the manuscript input circuit 14 in the image/manuscript synthesizing circuit 15 can be also applied.

The storing/reading circuit 16 is connected to a storage 6, an image selected by the stored image selecting circuit 18 is stored in the storage 6 and an image is read from the storage 6. That is, the storing/reading circuit 16 reads an image from the storage 6 according to an instruction from the displayed image selecting circuit 17 or the transmitted image selecting circuit 19 and sends the read image to the displaying circuit 12 or the transmitting/receiving circuit 13.

The displayed image selecting circuit 17 selects any of an image acquired by the image input circuit 11, manuscript information acquired by the manuscript input circuit 14, a synthetic image synthesized by the image/manuscript synthesizing circuit 14, an image stored in the storage by the storing/reading circuit 16 and an image received by the transmitting/receiving circuit 13 and the displaying circuit 12 displays it on LCD 3.

The stored image selecting circuit 18 selects any of an image acquired by the image input circuit 11, manuscript information acquired by the manuscript input circuit 14, a synthetic image synthesized by the image/manuscript synthesizing circuit 15 and an image received by the transmitting/receiving circuit 13, sends it to the storing/reading circuit 16 and the storing/reading circuit 16 stores the selected image in the storage 6.

The transmitted image selecting circuit 19 selects any of an image acquired by the image input circuit 11, manuscript information acquired by the manuscript input circuit 14, a synthetic image synthesized by the image/manuscript synthesizing circuit 15 and an image stored in the storage 6 by the storing/reading circuit 16 and the transmitting/receiving circuit 13 transmits the image via the radio transmitter-receiver 4.

In this embodiment, the camera 2, LCD 3, the radio transmitter-receiver 4, the pointing device 5 and the storage 6 are connected to the mobile telephone terminal 1, however, they may be also built in the mobile telephone terminal 1. Besides, the camera 2 may be also attached to the mobile telephone terminal 1 so that the camera can be detached. The functions of the mobile telephone terminal 1 itself are not shown, however, as they are well-known, the description is omitted.

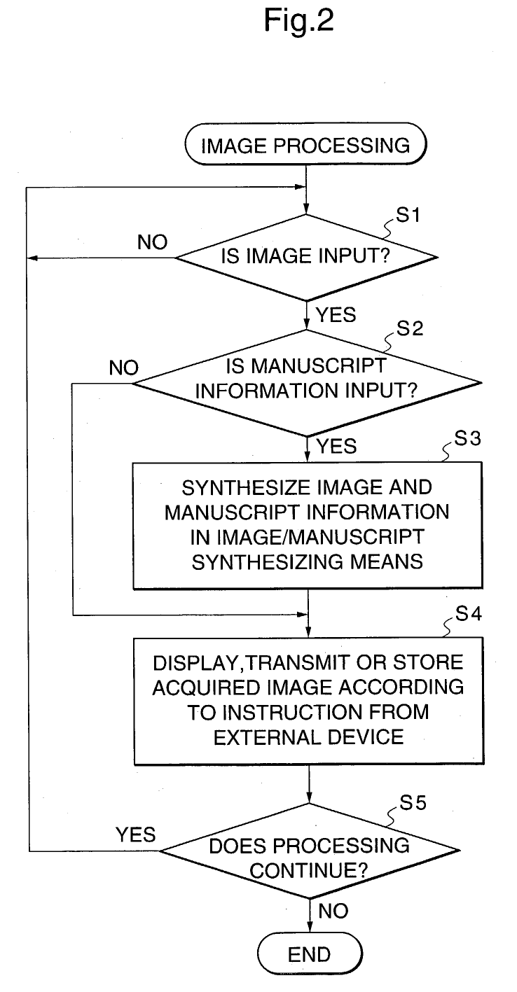

FIG. 2 is a flowchart showing the operation of the mobile telephone terminal 1 equivalent to one embodiment of the invention. Referring to FIGS. 1 and 2, the operation of the mobile telephone terminal 1 equivalent to one embodiment of the invention will be described below. A process shown in FIG. 2 is realized when CPU 21 executes a program on the record medium 20.

In the mobile telephone terminal 1, when the image input circuit 11 acquires an image photographed by the camera 2 (a step S1 in FIG. 2) and the manuscript input circuit 14 acquires manuscript information input from the pointing device 5 (a step S2 in FIG. 2), the image/manuscript synthesizing circuit 15 synthesizes the image acquired by the image input circuit 11 and the manuscript information acquired by the manuscript input circuit 14 to be a synthetic image (a step S3 in FIG. 2).

In the mobile telephone terminal 1, in case no manuscript information is input from the pointing device 5 (the step S2 in FIG. 2) or when synthesis by the image/manuscript synthesizing circuit 15 is finished, the displaying circuit 12 displays the acquired image, the transmitting/receiving circuit 13 transmits the acquired image or the storing/reading circuit 16 stores the acquired image according to an instruction from an external device (a step S4 in FIG. 2). The mobile telephone terminal 1 repeats the image processing described above until the termination of the processing is instructed (the steps S1 to S4 in FIG. 2).

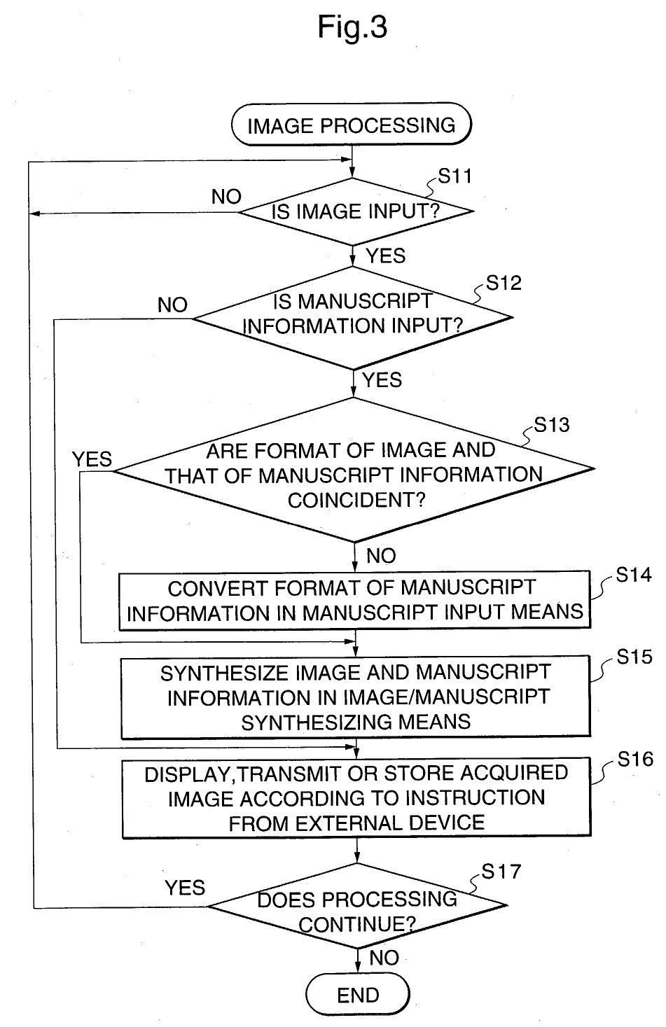

FIG. 3 is a flowchart showing the operation of a mobile telephone terminal equivalent to another embodiment of the invention. As the configuration of the mobile telephone terminal equivalent to another embodiment of the invention is the same as that of the mobile telephone terminal 1 equivalent to one embodiment of the invention and shown in FIG. 1, the operation of the mobile telephone terminal 1 equivalent to another embodiment of the invention will be described below referring to FIGS. 1 and 3. A process shown in FIG. 3 is realized when CPU 21 executes the program on the record medium 20.

In the mobile telephone terminal 1, when an image input circuit 11 acquires an image photographed by a camera 2 (a step S11 in FIG. 3) and a manuscript input circuit 14 acquires manuscript information input from a pointing device 5 (a step S12 in FIG. 3), the mobile telephone terminal determines whether the image acquired by the image input circuit 11 and the manuscript information acquired by the manuscript input circuit 14 have the same format or not (a step S13 in FIG. 3). In this case, information showing each format shall be added to the image acquired by the image input circuit 11 and the manuscript information acquired by the manuscript input circuit 14.

In the mobile telephone terminal 1, in case the image acquired by the image input circuit 11 and the manuscript information acquired by the manuscript input circuit 14 do not have the same format, the manuscript input circuit 14 or an image/manuscript synthesizing circuit 15 converts the format of the manuscript information (a step S14 in FIG. 3).

In the mobile telephone terminal 1, in case the image acquired by the image input circuit 11 and the manuscript information acquired by the manuscript input circuit 14 have the same format or when the conversion of the format is finished, the image/manuscript synthesizing circuit 15 synthesizes the image acquired by the image input circuit 11 and the manuscript information acquired by the manuscript input circuit 14 to be a synthetic image (a step S15 in FIG. 3).

In the mobile telephone terminal 1, in case no manuscript information is input from the pointing device 5 (the step S12 in FIG. 3) or when synthesis by the image/manuscript synthesizing circuit 15 is finished, a displaying circuit 12 displays the acquired image, a transmitting/receiving circuit 13 transmits the acquired image or a storing/reading circuit 16 stores the acquired image according to an instruction from an external device (a step S16 in FIG. 3). The mobile telephone terminal 1 repeats the image processing described above until the termination of the processing is instructed (the steps S11 to S17 in FIG. 3).

As described above, according to the invention, as manuscript information is written to an image by synthesizing the image acquired by the image input circuit 11 and the manuscript information acquired by the manuscript input circuit 14 in the image/manuscript synthesizing circuit 15, the manuscript information can be written in any image format and the image to which the manuscript information is written can be displayed on the whole display screen.

Besides, according to the invention, as manuscript information is written to an image as it is by synthesizing the image acquired by the image input circuit 11 and the manuscript information acquired by the manuscript input circuit 14 in the image/manuscript synthesizing circuit 15, a drawing (a picture) and a mark except a character can be also written to an image.

Therefore, according to the invention, if only an image can be displayed even if no displaying circuit corresponding to the file format of manuscript input information is provided, the manuscript input information can be also displayed and an image including the manuscript input information can be transmitted to a destination without requiring much processing time.

As described above, according to the invention, effect that if only an image can be displayed even if no displaying circuit corresponding to the file format of manuscript input information is provided, the manuscript input information can be also displayed by synthesizing an image from an image sensing device and manuscript input information input from an external device in the mobile telephone terminal to which the image sensing device can be connected and the image including the manuscript input information can be transmitted to a destination without requiring much processing time is obtained.

While this invention has been described in connection with certain preferred embodiments, it is to be understood that the subject matter encompassed by way of this invention is not limited to those specific embodiments. On the contrary, it is intended for the subject matter of the invention to include all alternatives, modifications, and equivalents as can be included within the spirit and scope of the following claims.

What is claimed is:

1. A mobile telephone terminal to which an image sensing device can be connected, comprising:
an image input circuit that acquires an image from the image sensing device;
a manuscript input circuit that acquires manuscript input information input from an external device; and
a synthesizing circuit that synthesizes the image acquired from the image input circuit and the manuscript input information acquired from the manuscript input circuit.

2. A mobile telephone terminal according to claim 1, wherein:
the manuscript input circuit acquires manuscript information input from a pointing device.

3. A mobile telephone terminal according to claim 1, comprising:
a circuit that converts the format of manuscript input information acquired from the manuscript input circuit to the format of an image acquired from the image input circuit when the format of the image and the format of the manuscript input information are different.

4. A mobile telephone terminal according to claim 2, comprising:
a circuit that converts the format of manuscript input information acquired from the manuscript input circuit to the format of an image acquired from the image input circuit when the format of the image and the format of the manuscript input information are different.

5. A manuscript information input method of a mobile telephone terminal to which an image sensing device can be connected, comprising:
a step for determining the acquisition of an image from the image sensing device;
a step for determining the acquisition of manuscript input information input from an external device; and
a step for synthesizing the acquired image and the manuscript input information when the image and the manuscript input information are acquired.

6. A manuscript information input method according to claim 5, wherein:
the manuscript input information is manuscript input information input from a pointing device.

7. A manuscript information input method according to claim 5, comprising:
a step for converting the format of manuscript input information acquired from the manuscript input circuit to the format of an image acquired from the image input circuit when the format of the image and the format of the manuscript input information are different.

8. A manuscript information input method according to claim 6, comprising:
a step for converting the format of manuscript input information acquired from the manuscript input circuit to the format of an image acquired from the image input circuit when the format of the image and the format of the manuscript input information are different.
